(19) United States
(12) Patent Application Publication
(10) Pub. No.: US 2007/0201101 A1
(43) Pub. Date: Aug. 30, 2007

(54) Multi-function peripheral device and method for providing a facsimile cover sheet

(76) Inventors: Fatima Corona, Long Beach, CA (US); Steve Livengood, Laguna Niguel, CA (US); Brian Podl, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,371

(22) Filed: Feb. 24, 2006

(51) Int. Cl. H04N 1/00

(52) U.S. Cl. 358/400; 358/468

(57) ABSTRACT

A multi-function peripheral device at which a user can prepare a facsimile cover sheet and a method for providing a facsimile cover sheet using a multi-function peripheral device are disclosed. The multi-function peripheral device includes a data storage storing a facsimile cover sheet template; a user interface configured to receive facsimile transmittal information from a user; a cover sheet generator configured to generate a facsimile cover sheet using the facsimile transmittal information and the facsimile cover sheet template; and a transmitter configured to transmit the facsimile cover sheet. The method includes the steps of receiving facsimile transmittal information from a user via a user interface of a multi-function peripheral device; generating a facsimile cover sheet using the facsimile transmittal information and a facsimile cover sheet template pre-stored in the multi-function peripheral device; and transmitting the facsimile cover sheet.

### BACKGROUND OF THE INVENTION

1. Field of the Invention

The invention relates to a facsimile device and a method for providing a facsimile cover sheet. More particularly, the invention relates to a facsimile device at which a user can prepare a facsimile cover sheet and a method for providing a facsimile cover sheet using the facsimile device.

2. Description of the Related Technology

When sending a facsimile message, it is customary to use a facsimile cover sheet containing facsimile transmittal information. The facsimile transmittal information typically includes a name, a fax number, a phone number of a recipient and a name and a telephone number of a sender. The facsimile transmittal information may also include the date of faxing, the number of faxed pages, comments, and so on.

A facsimile user may be provided with a pre-printed facsimile cover sheet template in which he can fill the transmittal information. Alternatively, the user may prepare a facsimile cover sheet using a word processor software program on a computer. In the latter case, the user may create a facsimile cover sheet from scratch. However, most word processor programs provide editable cover sheet templates. The user may select a cover sheet template and complete it using the keyboard of the computer. Then, the user may print out the completed cover sheet and use it when sending a facsimile message.

In certain circumstances, however, a facsimile user can avail himself of neither a pre-printed facsimile cover sheet template nor a computer with a word processor program when conducting a fax job. Therefore, there is a need to provide a facsimile device which is capable of generating a facsimile cover sheet.

### SUMMARY OF CERTAIN INVENTIVE ASPECTS

One aspect of the invention provides a multi-function peripheral (MFP) device having a facsimile capability. The MFP comprises: a data storage storing a facsimile cover sheet template; a user interface configured to receive facsimile transmittal information from a user; a cover sheet generator configured to generate a facsimile cover sheet using the facsimile transmittal information and the facsimile cover sheet template; and a transmitter configured to transmit the facsimile cover sheet.

The multi-function capability may comprise printer, scanner, and facsimile functions. The user interface may comprise an input device and a display device, at least one of which is integrated with the multi-function peripheral device. The user interface may comprise an input device and a display device, at least one of which is externally connected to the multi-function peripheral device. The user interface may comprise a general purpose computer externally connected to the multi-function peripheral device. The facsimile transmittal information may comprise facsimile sender and recipient information. The recipient information may comprise a facsimile number of a facsimile recipient, and the multi-function peripheral device may be configured to automatically dial the facsimile number of the facsimile recipient when transmitting a facsimile message.

In the MFP device, the data storage may be configured to store facsimile transmittal information, and the user interface may be configured to allow the user to select stored facsimile transmittal information. The data storage may be configured to store a plurality of customized facsimile cover sheets in which facsimile transmittal information has been provided, and the user interface may be configured to allow the user to select one of the customized facsimile cover sheets.

In the MFP device, the data storage may be configured to store a plurality of facsimile cover sheet templates. The user interface may be configured to allow the user to select one of the facsimile cover sheet templates and the cover sheet generator may be configured to generate a facsimile cover sheet using the facsimile transmittal information and the facsimile cover sheet template selected by the user.

The MFP device may further comprise a cover sheet template editor configured to allow a user to create or edit a facsimile cover sheet template. The cover sheet template editor may be operated via the user interface of the multi-function peripheral device. The cover sheet template editor may be operated remotely via a device-embedded user interface.

The facsimile cover sheet template may have been received from an external data storage device. The facsimile cover sheet template may be received from the external data storage device via a portable memory device, a direct link, or a network. The multi-function peripheral device may be configured to have access to a plurality of facsimile cover sheet templates stored in an external data storage device, and the user interface may be configured to allow the user to select one of the facsimile cover sheet templates stored in the external data storage device. The MFP device may further comprise a printer configured to print out the facsimile cover sheet.

Another aspect of the invention provides a multi-function peripheral device comprising: a data storage storing at least one facsimile cover sheet template; a user interface configured to allow a user to select one of the at least one cover sheet template; and a printer configured to print out a cover sheet template selected by the user.

Yet another aspect of the invention provides a multi-function peripheral device comprising: means for storing a facsimile cover sheet template; means for receiving facsimile transmittal information from a user; means for generating a facsimile cover sheet using the facsimile transmittal information and the facsimile cover sheet template; and means for transmitting the facsimile cover sheet.

In the MFP device, the means for storing may store a plurality of facsimile cover sheet templates and the receiving means may allow the user to select one of the facsimile cover sheet templates. In addition, the generating means may generate a facsimile cover sheet using the facsimile transmittal information and a facsimile cover sheet template selected by the user.

Another aspect of the invention provides a method of transmitting facsimile data comprising: receiving facsimile transmittal information from a user via a user interface of a multi-function peripheral device; generating a facsimile cover sheet using the facsimile transmittal information and a facsimile cover sheet template pre-stored in the multi-function peripheral device; and transmitting the facsimile cover sheet.

In the method, the facsimile transmittal information may comprise facsimile sender and recipient information. The recipient information may comprise a facsimile number of a facsimile recipient and transmitting the facsimile cover sheet may comprise automatically dialing the facsimile number of the facsimile recipient. Receiving the facsimile transmittal information may comprise allowing the user to select pre-stored facsimile transmittal information.

The method described above may further comprise: providing a plurality of facsimile cover sheet templates; and allowing the user to select one of the cover sheet templates, wherein generating the cover sheet may comprise incorporating the facsimile transmittal information in a facsimile cover sheet template selected by the user. At least one of the facsimile cover sheet templates may be received from an external device via a network connection.

Another aspect of the invention provides a method of providing a facsimile cover sheet template comprising: providing a plurality of facsimile cover sheet templates pre-stored in a multi-function peripheral device; allowing a user to select one of the facsimile cover sheet templates; and printing out a facsimile cover sheet template selected by the user.

Yet another aspect of the invention provides a system for transmitting facsimile data comprising: a data storage device storing a plurality of facsimile cover sheet template; and a multi-function peripheral device connected to the data storage device, the multi-function peripheral device comprising a user interface configured to allow a user to select one of the facsimile cover sheet templates. The system may further comprise a printing subsystem configured to print out a facsimile cover sheet template selected by the user. The user interface may be configured to receive facsimile transmittal information from the user, and the multi-function peripheral device may further comprise: a cover sheet generator configured to generate a facsimile cover sheet using the facsimile transmittal information and a facsimile cover sheet template selected by the user; and a transmitting device configured to transmit the facsimile cover sheet. The system may further comprise a data storage storing at least one facsimile cover sheet template.

### BRIEF DESCRIPTION OF THE DRAWINGS

FIG. 1 schematically illustrates a facsimile device for providing a facsimile cover sheet according to an embodiment of the invention.

FIG. 2 schematically illustrates the data storage of FIG. 1.

FIG. 3 is a flowchart of a method for providing a facsimile cover sheet according to an embodiment of the invention.

FIG. 4 is a flowchart of a method for providing a facsimile cover sheet according to another embodiment of the invention.

FIG. 5 is a flowchart of a method for providing a facsimile cover sheet according to yet another embodiment of the invention.

FIGS. 6A-6D illustrate a user interface of a facsimile device according to an embodiment of the invention.

FIG. 7 schematically illustrates a facsimile device which is capable of receiving facsimile cover sheet templates from external devices according to another embodiment of the invention.

FIG. 8 schematically illustrates a system for providing a facsimile cover sheet according to another embodiment of the invention.

FIG. 9 is a flowchart of a method for providing a facsimile cover sheet according to another embodiment of the invention.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

A facsimile device according to an embodiment of the invention provides a facsimile user with a facsimile cover sheet. The user may create a facsimile cover sheet, using the facsimile device. Alternatively, the user may print out a facsimile cover sheet template from the facsimile device. The user may also retrieve and use a facsimile cover sheet which he or she has previously used and stored in the facsimile device. Therefore, the user can avail himself of a facsimile cover sheet without a pre-printed cover sheet template or a computer with a word processor program.

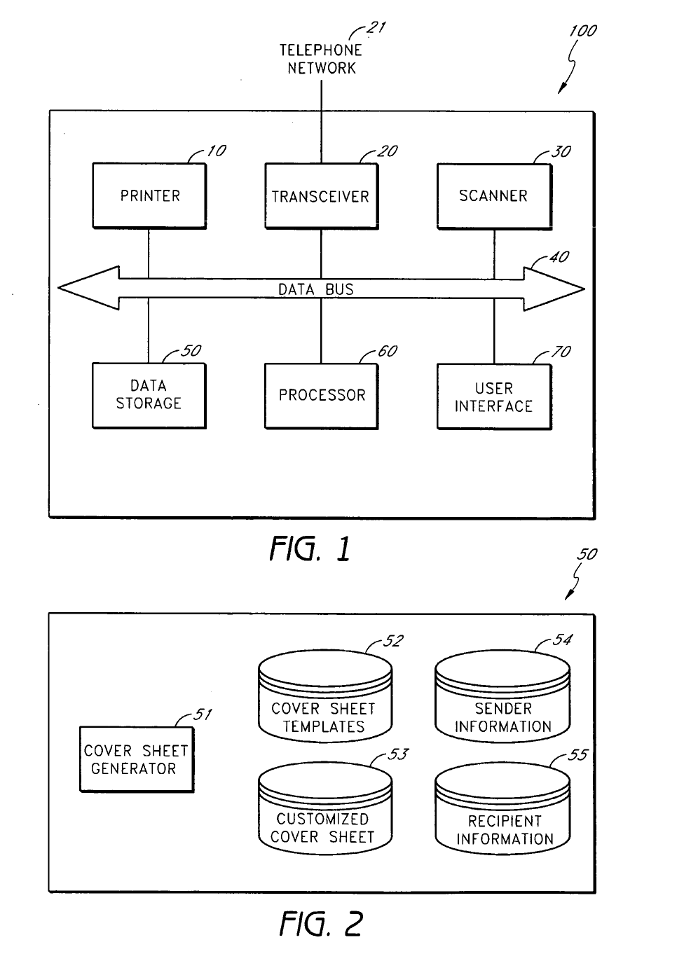

FIG. 1 illustrates a facsimile device 100 which is capable of providing a facsimile cover sheet according to an embodiment of the invention. The illustrated facsimile device 100 is an all-in-one multi-function peripheral (MFP) device with fax capabilities. The MFP functions may comprise a printer, a scanner, a photocopier, and a facsimile machine. In other embodiments, the facsimile device may be a dedicated facsimile machine. The device 100 includes a printer 10, a transceiver 20, a scanner 30, a data bus 40, a data storage 50, a processor 60, and a user interface 70. The printer 10, the transceiver 20, the scanner 30, the data storage 50, the processor 60, and the user interface 70 are electrically interconnected to one another via the data bus 40. The transceiver 20 is connected to a telephone network 21.

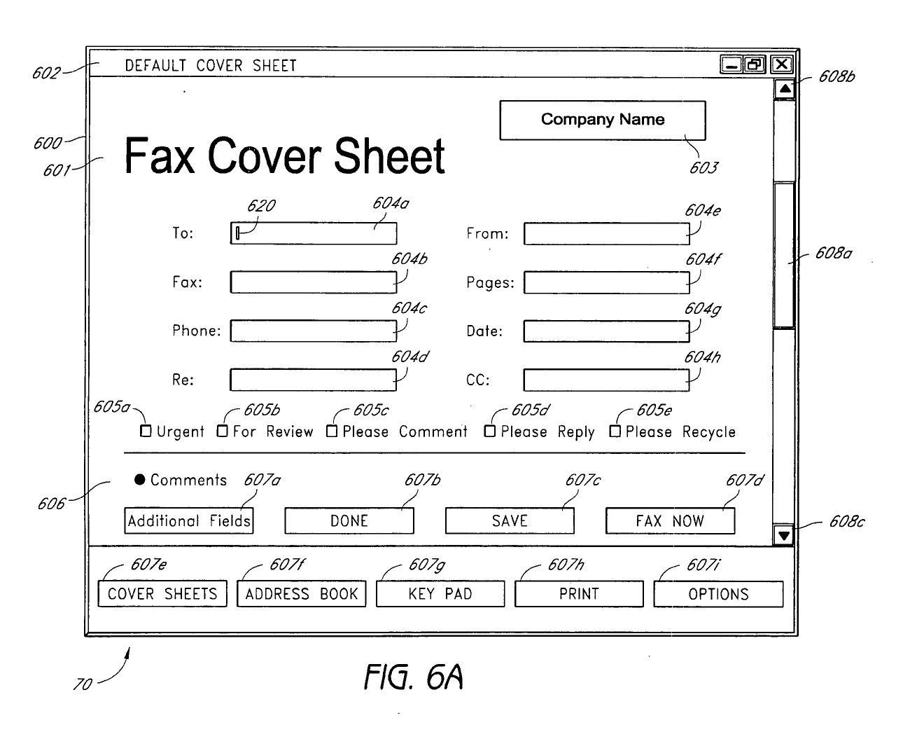

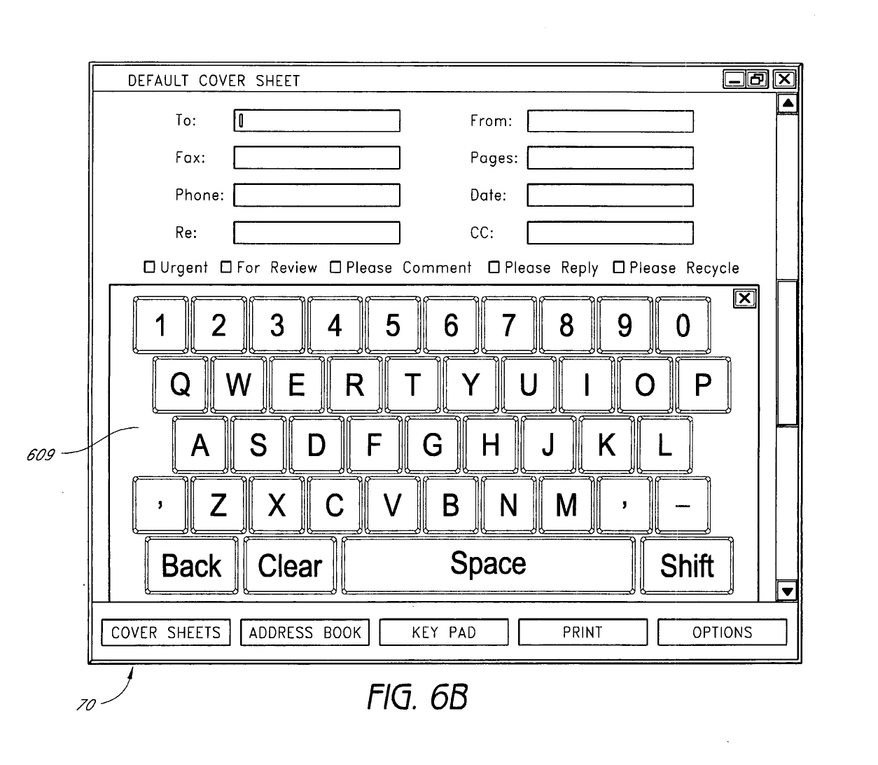

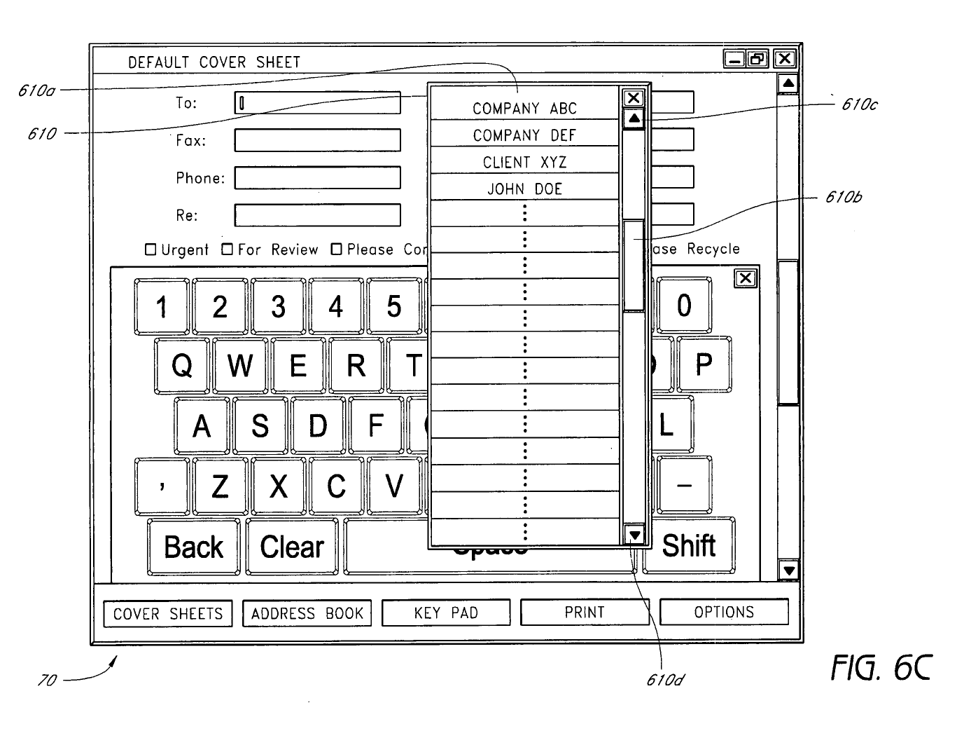

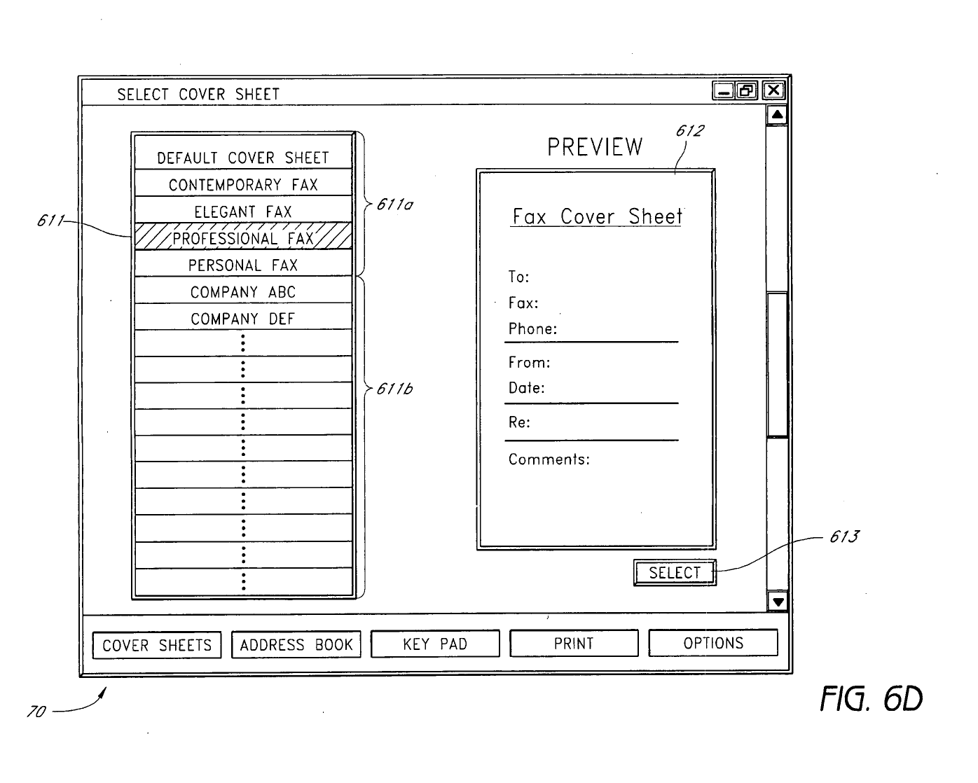

The printer 10 is a device which can convert electronic image data into physical documents. The transceiver 20 is a device which is capable of sending and receiving electronic data. The scanner 30 is a device which can scan physical documents and convert them into electronic image data. The data storage 50 is a device capable of storing electronic data which may include, but not be limited to, a hard disk, a flash memory, a RAM, a ROM, or a suitable combination of the foregoing. The processor 60 is a microprocessor of any suitable type which is capable of controlling the facsimile device 100 according to a software program and/or user instructions. The user interface 70 allows a user to interface with the facsimile device 100. The user interface 70 will be described below in detail with reference to FIGS. 6A-6D.

The printer 10, the transceiver 20, and the scanner 30 are, in combination, capable of conducting basic faxing operations. The basic faxing operations of the facsimile device 100 are identical to those of a conventional facsimile device. When sending a fax, the scanner 30 scans physical documents and converts them into electronic image data. The scanner 30 then sends the electronic image data to the transceiver 20. The transceiver 20 transmits the electronic image data over the telephone network 21 to a destination facsimile machine (not shown). In other embodiments, the scanner 30 may send the electronic image data to the data storage 50 to temporarily store the electronic image data. Then, the transceiver 20 retrieves the electronic image data from the data storage 50 and transmits it over the telephone network 21.

When receiving a fax, the transceiver 20 receives electronic image data over the telephone network 21 from an originating facsimile machine (not shown). Then, the transceiver 20 sends the data to the printer 10. The printer 10 converts the image data into physical documents. In other embodiments, the transceiver 20 may send the image data to the data storage 50 to temporarily store the data. Then, the printer 10 may retrieve the image data from the data storage 50 and print out physical documents. A skilled artisan will appreciate that various types of printers, transceivers and scanners can be employed for the facsimile device 100 based on needs of a user.

In the illustrated embodiment, the transceiver 20 is connected to the telephone network 21. In another embodiment, the transceiver 20 may be connected via a network adaptor to a network which is capable of transmitting electronic data. An exemplary network is the Internet. In the case of the Internet, a destination may be an email address of a recipient.

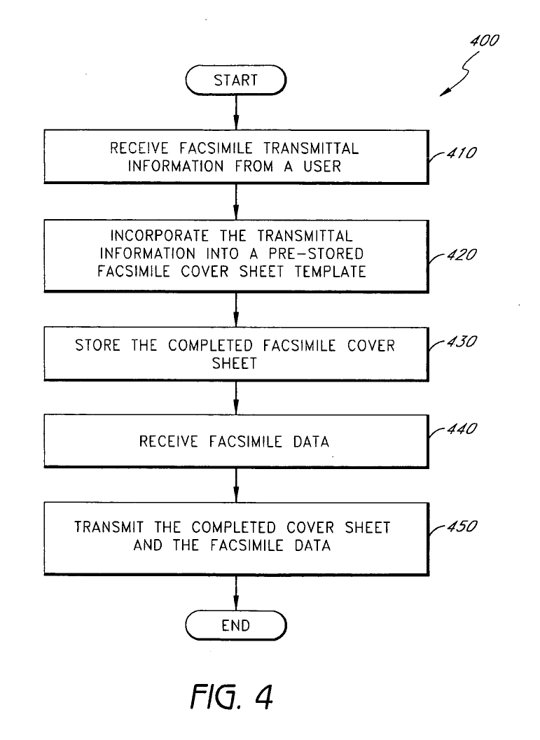

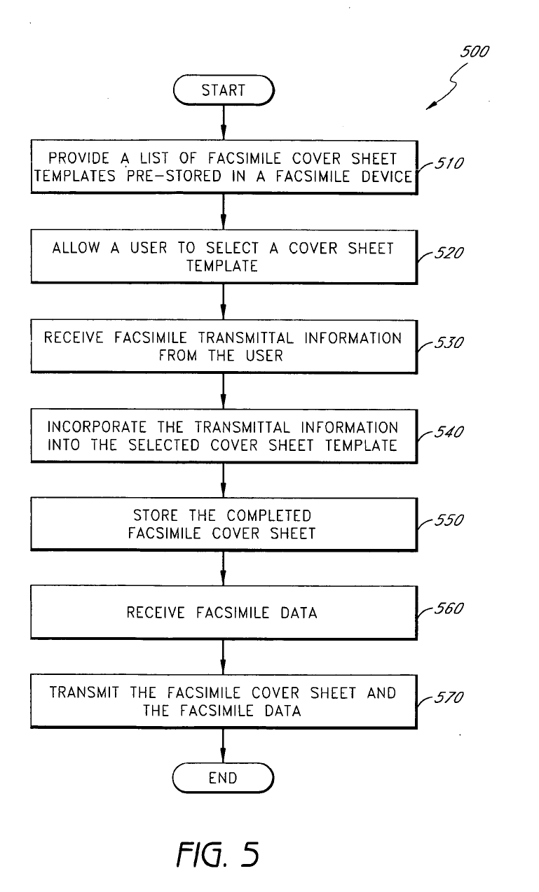

Referring to FIG. 2, the data storage 50 may be configured to include a cover sheet generator 51 and databases 52, 53, 54, and 55. The cover sheet generator 51 is typically embodied in the form of a computer software program. The cover sheet generator 51 is configured to incorporate facsimile transmittal information into a facsimile cover sheet template to generate a facsimile cover sheet. A facsimile cover sheet is a sheet which is customarily sent as the first page when faxing documents. A facsimile cover sheet template is a facsimile cover sheet with blanks for facsimile transmittal information. The transmittal information includes, but is not limited to, a recipient's name, fax number, and phone number, a sender's name and phone number, the date of faxing, the subject matter of a faxed message, the number of faxed pages, comments, and so forth. The operation of the cover sheet generator 51 will be described later in detail with reference to FIGS. 4 and 5.

The data storage 50 also contains a cover sheet template database 52, a sender information database 54, a recipient information database 55, and a customized cover sheet database 53. The databases are shown by way of example. The data storage 50 may have additional databases or may not have one or more of the databases shown in FIG. 2.

The facsimile cover sheet template database 52 contains at least one facsimile cover sheet template. The facsimile cover sheet template includes blanks for facsimile transmittal information. The facsimile cover sheet template may also include a sender's organization logo, styled letters, e.g., “FAX COVER SHEET,” and other information such as a confidential information notice. The facsimile cover sheet template 52 database may have a default cover sheet template and additional cover sheet templates in various styles.

In the illustrated embodiment, the data storage 50 also includes a sender information database 54 and a recipient information database 55. These databases 54, 55 allow a user to select and use transmittal information pre-stored in the facsimile device 100. The sender information database 54 may include senders' names, telephone numbers, organization names, addresses, email addresses, customized comments, etc. The recipient information database 55 may contain recipients' fax numbers, telephone numbers, addresses, email addresses, customized comments, etc. The use of the sender and recipient information databases 54, 55 will be explained in detail with reference to FIG. 6C.

The data storage 50 may also contain a customized cover sheet database 53. The customized cover sheet database 53 stores facsimile cover sheets which have been customized or frequently used. A customized cover sheet contains facsimile transmittal information including sender and recipient information that have been previously input by a user. However, a date of faxing on the customized cover sheet may remain blank. The date may be automatically filled in with an actual date of faxing when conducting a fax job.

Cover Sheet Generation

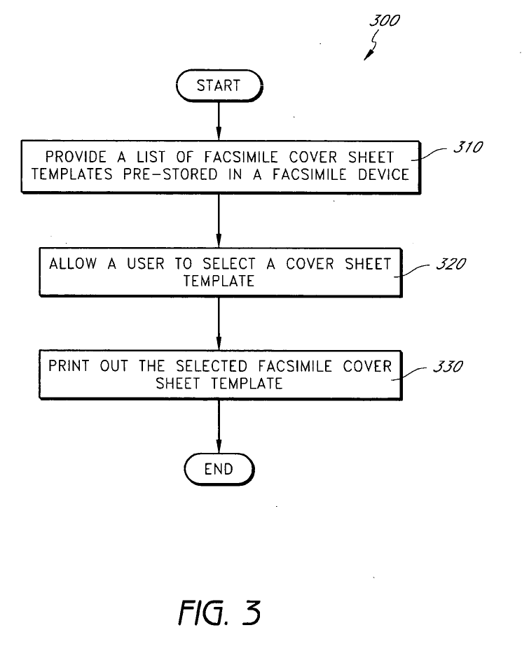

Referring to FIGS. 1-3, an embodiment of a method 300 of generating a facsimile cover sheet is described. In the method illustrated in FIG. 3, a facsimile cover sheet template is pre-stored in a facsimile device and is printed out upon a user's request. In block 310, a user is provided with a list of facsimile cover sheet templates pre-stored in the cover sheet template database 52 of the facsimile device 100. Then, in block 320, the user is allowed to select one of the facsimile cover sheet templates using the user interface 70. Upon the user's request, the printer 10 prints out the selected cover sheet template. The printed cover sheet template has blanks for facsimile transmittal information. The user may write or type transmittal information in the blanks on the cover sheet template. Then, the user can send the completed cover sheet along with other documents using the facsimile device 100. In another embodiment, a user may not be provided with a list of pre-stored facsimile cover sheet templates, but only with a default facsimile cover sheet template. In the embodiment, the user can print out only the default cover sheet template for use in faxing.

Referring to FIGS. 1, 2 and 4, another embodiment of a method 400 of generating a facsimile cover sheet is described. According to the embodiment illustrated in FIG. 4, a user may use an electronic facsimile cover sheet instead of a physical copy of facsimile cover sheet template as described above with reference to FIG. 3. The user interface 70 of the facsimile device 100 allows the user to select a facsimile cover sheet generation function. Upon the user's request, the cover sheet generator 51 is retrieved from the data storage 50 and is run on the processor 60.

The following process is conducted by the facsimile cover sheet generator 51. In block 410 of FIG. 4, facsimile transmittal information is received from the user via the user interface 70. The transmittal information includes sender information and recipient information. The sender information may include a sender's name, telephone number, company name, comments, etc. The recipient information may include a recipient's name, fax number, telephone number, etc. The transmittal information is then transmitted to the data storage 50. The transmittal information is temporarily stored in the data storage 50. In another embodiment, the transmittal information may be permanently saved for a future use at the user's request. The block 410 of receiving transmittal information will now be described in more detail with reference to FIGS. 6A-6C.

In the illustrated embodiment of the method, the user may input the transmittal information using the user interface 70. An embodiment of the user interface 70 is shown in FIGS. 6A-6C. In this embodiment, the user interface 70 is a touch screen display 600 which functions both as a display device and as an input device. In other embodiments, the user interface may include a display device and a keypad or keyboard. The user interface 70 may be integrated in the facsimile device 100 or externally connected to the facsimile device 100. The display device may be an LCD or CRT display, for example. In certain embodiments, the user interface 70 may be a general purpose computer directly connected to the facsimile device 100. In other embodiments, the user interface 70 may be a computer indirectly connected over a network to the facsimile device 100.

FIG. 6A illustrates an input window 601 which allows a user to input facsimile transmittal information. The input window 601 includes a title bar 602, a sender's organization name field 603, sender/recipient information fields 604a-604h, check boxes 605a-605e, a comment blank 606, function buttons 607a-607i, a scroll bar 608a, and scroll buttons 608b and 608c. In other embodiments, the input window 601 may include various additional information fields depending on needs of the user. The user may access these additional information fields by touching an “ADDITIONAL FIELDS” button 607a.

When entering the transmittal information, the user may touch a blank in which the user desires to fill information. For example, if the user desires to input a recipient name, he may touch a “To” blank 604a. Then, a cursor 620 appears in the “To” blank 604a. To input letters, the user may touch a “KEYPAD” button 607g. Then, a keypad 609 pops up on the touch screen display 600 as shown in FIG. 6B. The user may input letters and/or numbers by touching the keypad 609 on the touch screen display 600.

Alternatively, the user may use facsimile transmittal information pre-stored in the sender and recipient information databases 54 and 55 of FIG. 2. To have access to the databases 54, 55, the user may touch an “ADDRESS BOOK” button 607f of FIG. 6A. Then, a window 610 showing a list of names 610a appears adjacent to a blank in which the cursor 620 is blinking, for example, the “To” blank 604a for a recipient name as shown in FIG. 6C. The user can find a name by scrolling up and down the list 610a with a scroll bar 610b or scroll buttons 610c and 610d. Once the user has found the desired name, he or she can simply touch the name on the list 610a. The name then appears in the “To” blank 604a. In addition, recipient facsimile information such as a fax number and/or a phone number associated with the name is automatically filled in the “Fax” and/or “Phone” blanks 604b and 604c. Similarly, the other blanks 604d-604h, the check boxes 605a-605e, and the comment blank 606 can be completed using either the keypad 609 or the address book window 610. The user may elect to leave any of the blanks or the check boxes unfilled, depending on his or her needs.

In the illustrated embodiment, once the user is finished with completing the blanks and/or the check boxes on the input window 601, he or she may now touch a “DONE” button 607b. By touching the “DONE” button 607b, the facsimile transmittal information which the user has input is temporarily stored in the data storage 50 of FIG. 1. The user may also elect to permanently save the transmittal information for a future use. By touching a “SAVE” button 607c, the transmittal information is stored in the sender and/or recipient information databases 54 and 55 of FIG. 2. Furthermore, the user may save the entire cover sheet for a future use in the customized cover sheet database 53 of FIG. 2. In addition, the user may print out a physical copy of the completed cover sheet by touching a “PRINT” button 607h.

Referring back to FIG. 4, in block 420, the transmittal information is incorporated into a default facsimile cover sheet template pre-stored in the data storage 50 of the facsimile device 100 of FIG. 1. Then, in block 430, the completed facsimile cover sheet is stored in the data storage 50. The blocks 420 and 430 are conducted by the cover sheet generator 51 of FIG. 2.

In block 440, the user may feed facsimile messages such as documents and photos into the facsimile device. The scanner 30 of FIG. 1 receives the facsimile messages and converts them into electronic image data. The image data is sent to and temporarily stored in the data storage 50.

In block 450, upon receiving a “fax” instruction, the completed cover sheet and the image data stored in the data storage 50 are sent in sequence to the transceiver 20 of FIG. 1. Referring back to FIG. 6A, the user can provide the “fax” instruction by touching a “FAX NOW” button 607d. The transceiver 20 then transmits the cover sheet and the image data over the telephone network 21 to a destination facsimile machine. When connecting to the destination facsimile machine, the transceiver 20 automatically dial a destination fax number which has been input by the user in the block 410. In certain embodiments, the date of faxing is automatically entered using an electronic calendar (not shown) embedded in the facsimile device 100. In another embodiment, the number of pages to be faxed is automatically calculated and entered upon feeding documents into the facsimile device 100.

Referring now to FIGS. 1, 2, 5, and 6A-6D, another embodiment of a method 500 of generating a facsimile cover sheet is described. In block 510 of FIG. 5, a user is provided with a list of facsimile cover sheet templates pre-stored in the cover sheet template database 52 of FIG. 2.

The user is then allowed to select a cover sheet template using the user interface 70 of the facsimile device 100 of FIG. 1. In the illustrated embodiment, the user interface 70 is the touch screen display 600 of FIG. 6A. The user may touch a “COVER SHEETS” button 607e on the touch screen display 600. Referring to FIG. 6D, a list 611 of cover sheet templates then appears on the display 600. The list 611 provides not only cover sheet templates 611a, but also customized cover sheets 611b stored in the customized cover sheet database 53 of FIG. 2. In the illustrated embodiment, the display 600 also shows a preview 612 of a cover sheet template.

Then, in block 520 of FIG. 5, the user is allowed to select one of the facsimile cover sheet templates using the user interface. The user may select a cover sheet by touching a desired cover sheet template on the list 611 of FIG. 6D and then touching a “SELECT” button 613 of FIG. 6D.

In block 530 of FIG. 5, facsimile transmittal information is received from the user via the user interface 70 as described above with reference to block 410 of FIG. 4. The transmittal information is transmitted to and stored in the data storage 50 of FIG. 1. In block 540, the cover sheet generator 51 incorporates the transmittal information into the selected facsimile cover sheet template. Then, in block 550, the cover sheet generator 51 stores the completed facsimile cover sheet in the data storage 50.

In block 560, the user may feed facsimile messages such as documents and photos into the facsimile device 100. The scanner 30 receives the facsimile messages and converts them into electronic image data. The image data is sent to and temporarily stored in the data storage 50.

In block 570, upon receiving a “fax” instruction, the completed cover sheet and the image data stored in the data storage 50 are sent in sequence to the transceiver 20 of FIG. 1. The transceiver 20 in turn transmits them over the telephone network 21 to a destination facsimile. When connecting to the destination facsimile, the transceiver automatically dial a destination fax number that has been input in block 530. In certain embodiments, the date of faxing is automatically entered using an electronic calendar (not shown) embedded in the facsimile device 100. In another embodiment, the number of pages to be faxed is automatically calculated and entered upon feeding documents into the facsimile device 100.

Cover Sheet Template Creation/Edition

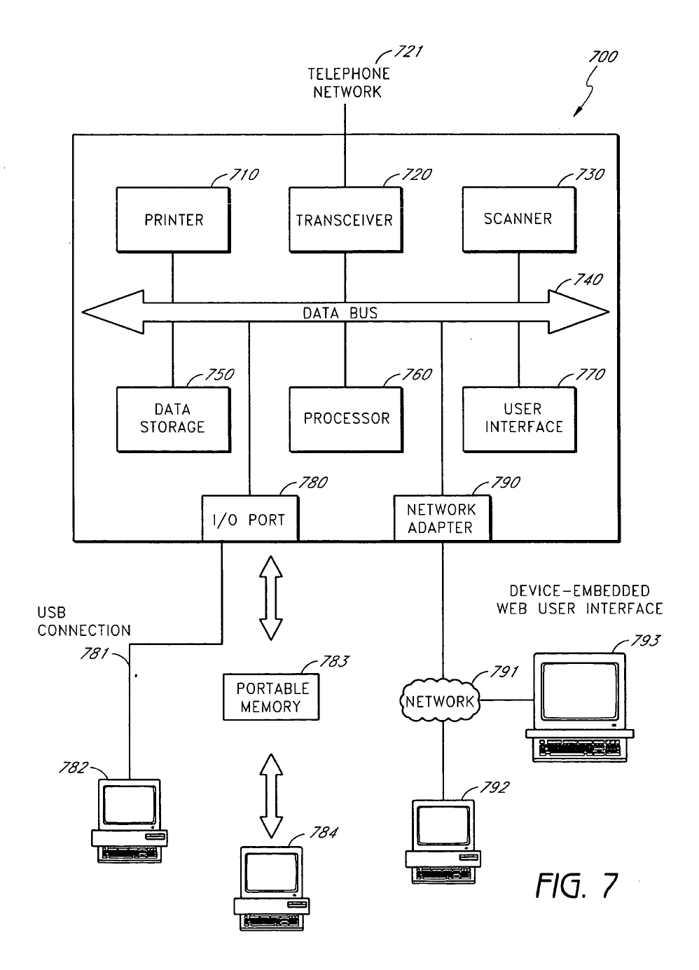

Referring to FIG. 7, another embodiment of a facsimile device is described. The illustrated facsimile device 700 includes a printer 710, a transceiver 720, a scanner 730, a data bus 740, a data storage 750, a processor 760, a user interface 770, an I/O port 780, and a network adaptor 790. The printer 710, the transceiver 720, the scanner 730, the data storage 750, the processor 760, the user interface 770, the I/O port 780, and the network adaptor 790 are interconnected to one another via the data bus 740. The faxing and cover sheet generating operations of the facsimile device 700 are identical to those of the facsimile device 100 described above with reference to FIG. 1.

According to the illustrated embodiment, facsimile cover sheet templates may be created and/or edited using a cover sheet template editor. “Creating” or “editing,” as used herein, refers to generating or revising a facsimile cover sheet template with blank fields to be completed by a user. An administrator or user of the facsimile device 700 may create a cover sheet template in a style different from that of a default facsimile cover sheet template. The administrator or user may also add or change transmittal information fields, logos, lines, shapes, etc., depending on his or her needs. The cover sheet templates created or edited using the cover sheet template editor are stored in the data storage 750 for a future use.

The cover sheet template editor (not shown) is a computer software program. The program can be operated on any type of processor, including a microprocessor and a CPU of a general purpose computer. In one embodiment, the cover sheet template editor may be a word processor program commercially available from software companies, for example, Microsoft Word®. In other embodiments, the cover sheet template editor may be a software program dedicated to cover sheet editing.

In one embodiment, the cover sheet template editor is stored in the data storage 750 of the facsimile device 700. Upon the administrator or user's request, the cover sheet template editor is retrieved from the data storage 750 and is run on the processor 760 of the facsimile device 100. The administrator or user may create or edit a cover sheet template using the user interface 770 of the facsimile device 700. In the illustrated embodiment, the user interface 770 is a touch screen display which has both display and input functions. In other embodiments, the user interface may include a display device and a keypad or keyboard. The user interface 770 may be integrated in the facsimile device 700 or externally connected to the facsimile device 700. The display device may be an LCD or CRT display. Using the user interface 770, the administrator may create or edit a cover sheet template and store it in the data storage 750. The cover sheet template created or edited using the cover sheet template editor is stored in the data storage 750 for a future use.

The administrator may have access to the cover sheet template editor from an external device connected directly to the facsimile device 700. The external device may be a general purpose computer 782 connected via the I/O port 780 to the facsimile device 700. In the illustrated embodiment, the computer 782 is connected to the facsimile device through USB connection.

The external device may also be a general purpose computer 793 connected over a network 791 to the facsimile device 700. For the network connection, the facsimile device includes the network adaptor 790. The administrator may have access to the cover sheet template editor via a device-embedded web user interface. “Device-embedded user interface,” as used herein, refers to a user interface which allows a user to access a software program stored in a remote device over a network 791. Examples of the network 791 include, but are not limited to, a LAN, a WAN, the Internet, or a wireless network. By way of example, when creating or editing a cover sheet template, the administrator may use a web browser such as Internet Explorer® or Netscape®. The device-embedded user interface may be invoked by typing the IP address or hostname of the facsimile device 700 in the address window of the web browser. An example of the device-embedded user interface is Samsung's Web SyncThru®. Cover sheet templates created or edited using the cover sheet template editor via the device-embedded user interface 793 are stored in the data storage 750 for a future use.

In another embodiment, the cover sheet template editor may be stored and operated on an external device such as a general purpose computer. For example, cover sheet template editors may be stored and run on general purpose computers 782, 784, and 792 of FIG. 7. The administrator or user may create or edit facsimile cover sheet templates using the cover sheet template editors on the computers 782, 784, and 792. The administrator or user may also store the cover sheet templates in a memory or hard disk of the computers 782, 784, and 792.

The cover sheet templates created or edited on the computers can be transmitted to the facsimile device 700 via a direct connection 781. In the illustrated embodiment, the direct connection is a USB connection. The cover sheet templates may also be forwarded indirectly via a portable memory 783. The portable memory 783 can be of any suitable type which can store electronic data. Examples of the portable memory include, but are not limited to, a flash memory, a floppy diskette, a zip diskette, a portable hard disk, a USB memory device, a CD-ROM, a CD-RW, and a smart card. The administrator may use an encryption method if the templates contain confidential information. The templates may also be sent from the computer 792 over a network 791 to the facsimile device 700. The cover sheet templates transferred from the computers 782, 784, and 792 are stored in the data storage 750 for a future use.

Remote Cover Sheet Template Access

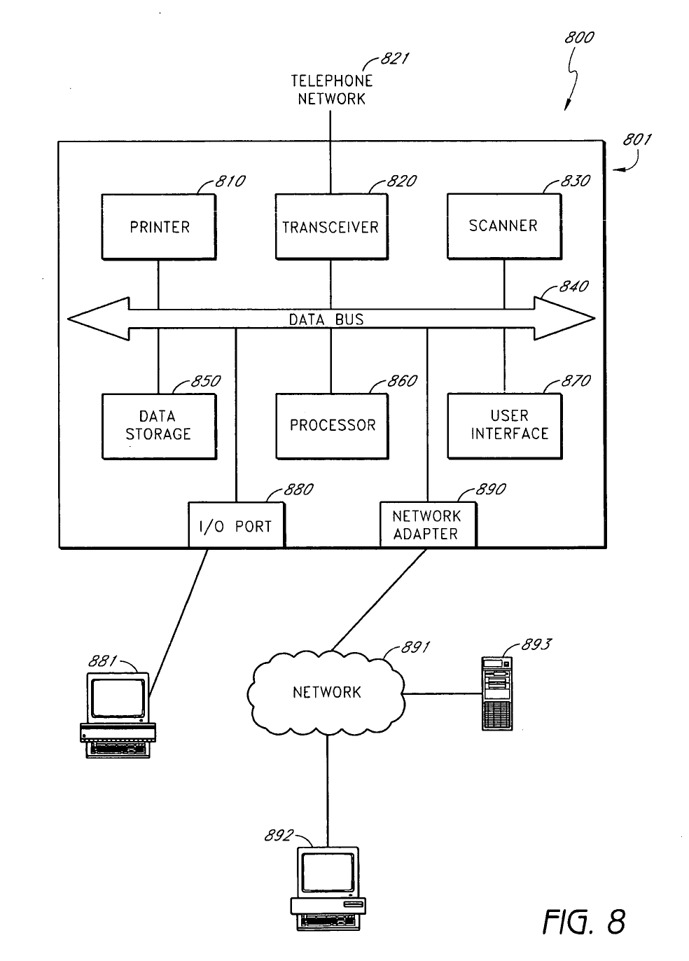

Referring to FIG. 8, a system 800 for transmitting facsimile data according to one embodiment is described. The illustrated system 800 includes a facsimile device 801 and external data storage devices 881, 892, 893. The facsimile device 801 includes a printer 810, a transceiver 820, a scanner 830, a data bus 840, a data storage 850, a processor 860, a user interface 870, an I/O port 880, and a network adaptor 890. The printer 810, the transceiver 820, the scanner 830, the data storage 850, the processor 860, the user interface 870, the I/O port 880, and the network adaptor 890 are interconnected to one another via the data bus 840. The basic faxing operation of the facsimile device 800 is identical to that described above with reference to the facsimile device 100 of FIG. 1.

In the illustrated embodiment, the system 800 also includes external data storage devices. The external data storage devices may include general purpose computers 881, 892. The external data storage devices may also include a server 893. Each of the computers 881, 892 and the server 893 has data storage such as a hard disk drive, a ROM, a flash memory, etc. The computer 881 is directly connected to the facsimile device 800. The computer 892 and the server 894 are connected over a network 891 to the facsimile device 800. The network 891 can be of any suitable type for electronic data transmission, including a LAN, a WAN, the Internet, and a wireless network. Each of the external devices 881, 892, and 893 includes at least one facsimile cover sheet template in its own data storage. The at least one facsimile cover sheet template may be one that has been created or edited on the computer 881, 892 or the server 893 in which the template is stored. In other embodiments, the templates may be ones that have been created on and transmitted from another device.

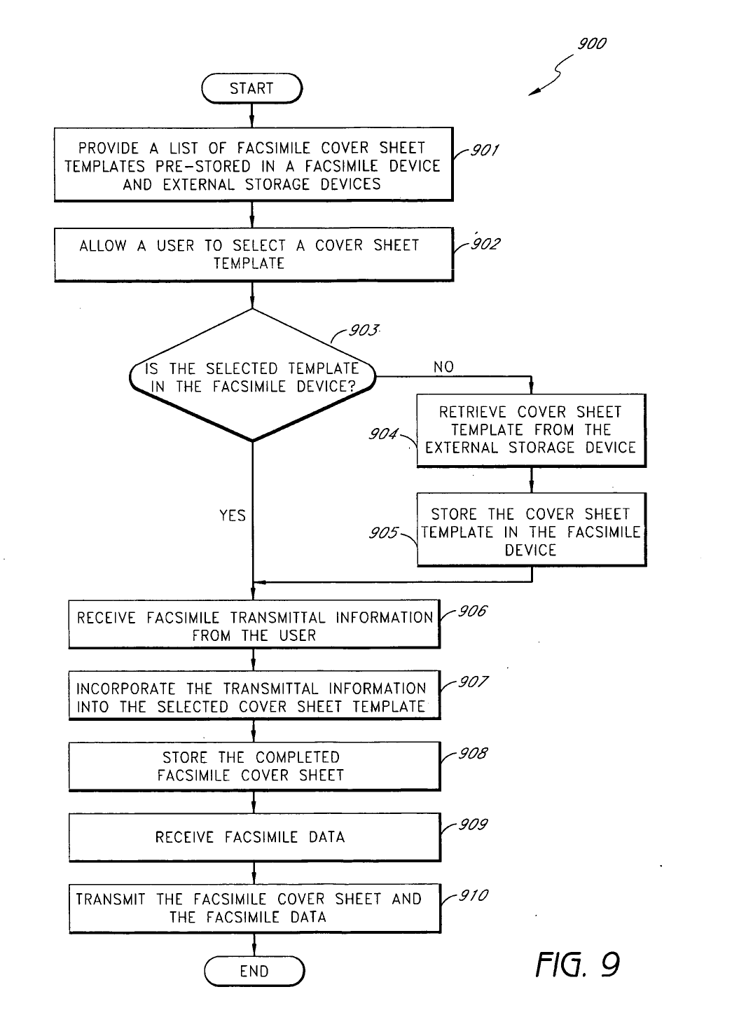

Referring to FIGS. 8 and 9, an embodiment of a method 900 of transmitting facsimile data is described. In block 901 of FIG. 9, a user is provided with a list of facsimile cover sheet templates. The list provides not only cover sheet templates stored in the data storage 850 of the facsimile device 800, but also templates stored in the external data storage devices 881, 892, and 893.

Subsequently, in block 902 of FIG. 9, the user is allowed to select one of the facsimile cover sheet templates via the user interface 870. The block 902 of selecting a cover sheet template is identical to block 520 of the method 500 described above with respect to FIG. 5 except that the user can choose a cover sheet template in the external devices 881, 892, and 893.

Next in block 903 of FIG. 9, it is determined whether the selected template is in the facsimile device 801 of FIG. 8. If yes, facsimile transmittal information is then received from the user via the user interface 870 in block 906 as described above with reference to block 410 of FIG. 4. On the other hand, if the answer is no, i.e., if the template is in one of the external devices 881, 892, and 893, the template is retrieved from the external device as shown in block 904 of FIG. 9. Then, the template is stored in the data storage 850 of the facsimile device 801 of FIG. 8. The template may be temporarily or permanently saved in the data storage 850, depending on the needs of the user. Next, facsimile transmittal information is received from the user via the user interface 870 in block 906.

The transmittal information is then sent to and stored in the data storage 850. In block 907 of FIG. 9, the transmittal information is incorporated into the selected facsimile cover sheet template. Then, in block 908, the completed facsimile cover sheet is stored in the data storage 850.

In block 909, the user may feed facsimile messages such as documents and photos into the facsimile device 800. The scanner 830 receives the facsimile messages and converts them into electronic image data. The image data is sent to and temporarily stored in the data storage 850.

In block 910, upon receiving a “send” instruction, the completed cover sheet and the image data stored in the data storage 850 are sent in sequence to the transceiver 820. The transceiver 820 in turn transmits them over the telephone network 821 to a destination facsimile. When connecting to the destination facsimile, the transceiver automatically dial a destination fax number that has been input by the user in block 906. In certain embodiments, the date of faxing is automatically entered using an electronic calendar (not shown) embedded in the facsimile device 801. In another embodiment, the number of faxed pages may be automatically calculated and entered upon feeding documents into the facsimile device 801.

The foregoing description is that of embodiments of the invention and various changes, modifications, combinations and sub-combinations may be made without departing from the spirit and scope of the invention, as defined by the appended claims.

What is claimed is:

1. A multi-function peripheral (MFP) device having a facsimile capability, comprising:
a data storage storing a facsimile cover sheet template;
a user interface configured to receive facsimile transmittal information from a user;
a cover sheet generator configured to generate a facsimile cover sheet using the facsimile transmittal information and the facsimile cover sheet template; and
a transmitter configured to transmit the facsimile cover sheet.

2. The multi-function peripheral device of claim 1, wherein the multi-function comprises printer, scanner, and facsimile functions.

3. The multi-function peripheral device of claim 1, wherein the user interface comprises an input device and a display device, at least one of which is integrated with the multi-function peripheral device.

4. The multi-function peripheral device of claim 1, wherein the user interface comprises an input device and a display device, at least one of which is externally connected to the multi-function peripheral device.

5. The multi-function peripheral device of claim 1, wherein the user interface comprises a general purpose computer externally connected to the multi-function peripheral device.

6. The multi-function peripheral device of claim 1, wherein the facsimile transmittal information comprises facsimile sender and recipient information.

7. The multi-function peripheral device of claim 6, wherein the recipient information comprises a facsimile number of a facsimile recipient, and wherein the multi-function peripheral device is configured to automatically dial the facsimile number of the facsimile recipient when transmitting a facsimile message.

8. The multi-function peripheral device of claim 1, wherein the data storage is configured to store facsimile transmittal information, and wherein the user interface is configured to allow the user to select stored facsimile transmittal information.

9. The multi-function peripheral device of claim 1, wherein the data storage is configured to store a plurality of customized facsimile cover sheets in which facsimile transmittal information has been provided, and wherein the user interface is configured to allow the user to select one of the customized facsimile cover sheets.

10. The multi-function peripheral device of claim 1, wherein the data storage is configured to store a plurality of facsimile cover sheet templates;
wherein the user interface is configured to allow the user to select one of the facsimile cover sheet templates; and
wherein the cover sheet generator is configured to generate a facsimile cover sheet using the facsimile transmittal information and the facsimile cover sheet template selected by the user.

11. The multi-function peripheral device of claim 1, further comprising a cover sheet template editor configured to allow a user to create or edit a facsimile cover sheet template.

12. The multi-function peripheral device of claim 11, wherein the cover sheet template editor is operated via the user interface of the multi-function peripheral device.

13. The multi-function peripheral device of claim 11, wherein the cover sheet template editor is operated remotely via a device-embedded user interface.

14. The multi-function peripheral device of claim 1, wherein the facsimile cover sheet template has been received from an external data storage device.

15. The multi-function peripheral device of claim 14, wherein the facsimile cover sheet template is received from the external data storage device via a portable memory device, a direct link, or a network.

16. The multi-function peripheral device of claim 1, wherein the multi-function peripheral device is configured to have access to a plurality of facsimile cover sheet templates stored in an external data storage device, and
wherein the user interface is configured to allow the user to select one of the facsimile cover sheet templates stored in the external data storage device.

17. The multi-function peripheral device of claim 1, further comprising a printer configured to print out the facsimile cover sheet.

18. A multi-function peripheral device comprising:
a data storage storing at least one facsimile cover sheet template;
a user interface configured to allow a user to select one of the at least one cover sheet template; and
a printer configured to print out a cover sheet template selected by the user.

19. A multi-function peripheral device comprising:
means for storing a facsimile cover sheet template;
means for receiving facsimile transmittal information from a user;
means for generating a facsimile cover sheet using the facsimile transmittal information and the facsimile cover sheet template; and
means for transmitting the facsimile cover sheet.

20. The multi-function peripheral device of claim 19, wherein the means for storing stores a plurality of facsimile cover sheet templates;
wherein the receiving means allows the user to select one of the facsimile cover sheet templates; and
wherein the generating means generates a facsimile cover sheet using the facsimile transmittal information and a facsimile cover sheet template selected by the user.

21. A method of transmitting facsimile data comprising:
receiving facsimile transmittal information from a user via a user interface of a multi-function peripheral device;
generating a facsimile cover sheet using the facsimile transmittal information and a facsimile cover sheet template pre-stored in the multi-function peripheral device; and
transmitting the facsimile cover sheet.

22. The method of claim 21, wherein the facsimile transmittal information comprises facsimile sender and recipient information.

23. The method of claim 22, wherein the recipient information comprises a facsimile number of a facsimile recipient and wherein transmitting the facsimile cover sheet comprises automatically dialing the facsimile number of the facsimile recipient.

24. The method of claim 21, wherein receiving the facsimile transmittal information comprises allowing the user to select pre-stored facsimile transmittal information.

25. The method of claim 21, further comprising:
providing a plurality of facsimile cover sheet templates; and
allowing the user to select one of the cover sheet templates,
wherein generating the cover sheet comprises incorporating the facsimile transmittal information in a facsimile cover sheet template selected by the user.

26. The method of claim 25, wherein at least one of the facsimile cover sheet templates is received from an external device via a network connection.

27. A method of providing a facsimile cover sheet template comprising:
providing a plurality of facsimile cover sheet templates pre-stored in a multi-function peripheral device;
allowing a user to select one of the facsimile cover sheet templates; and
printing out a facsimile cover sheet template selected by the user.

28. A system for transmitting facsimile data comprising:
a data storage device storing a plurality of facsimile cover sheet template; and
a multi-function peripheral device connected to the data storage device, the multi-function peripheral device comprising a user interface configured to allow a user to select one of the facsimile cover sheet templates.

29. The system of claim 28, further comprising a printing subsystem configured to print out a facsimile cover sheet template selected by the user.

30. The system of claim 28, wherein the user interface is configured to receive facsimile transmittal information from the user, and
wherein the multi-function peripheral device further comprises:
a cover sheet generator configured to generate a facsimile cover sheet using the facsimile transmittal information and a facsimile cover sheet template selected by the user; and
a transmitting device configured to transmit the facsimile cover sheet.

31. The system of claim 28, further comprising a data storage storing at least one facsimile cover sheet template.
